(19) United States
(12) Patent Application Publication
(10) Pub. No.: US 2004/0098616 A1
(43) Pub. Date: May 20, 2004

(54) Communications firewall

(76) Inventors: Bruce Stephen Jenner, North Vancouver (CA); Henrik Thorning Christensen, Tsawwassen (CA)

Correspondence Address: DORSEY & WHITNEY LLP, INTELLECTUAL PROPERTY DEPARTMENT, SUITE 3400, 1420 FIFTH AVENUE, SEATTLE, WA, 98101, US

(21) Appl. No.: 10/298,162

(22) Filed: Nov. 14, 2002

(51) Int. Cl. G06F 11/30

(52) U.S. Cl. 713/201

(57) ABSTRACT

An energy exchange network provides services to users through a firewall. The firewall includes a plurality of ports and a plurality of services. Access to a client through the firewall is controlled by mapping a port to a service so that at any given time, the client is communicating with one service via one port. A different service must access the client through a different port. Typically, services are provided sequentially so that access through the ports is also sequential, a service is not given more access than needed at any point in the sequence, hence a user can only respond to the service currently connected and cannot access other services.

### FIELD OF THE INVENTION

The present invention relates to communications firewalls and is particularly concerned with wireless access to an internet protocol network.

### BACKGROUND OF THE INVENTION

Within a network, various security measures can be put into place to create what is referred to as a “trusted” network. Such methods cannot control access from would-be users attempting to access a local area network either from the Internet or via direct communication with a local area network (LAN), such as a wireless LAN. A known way to protect a LAN is by providing a gateway computer (also known as a firewall) to isolate local users. By definition, a firewall is a device that protects a LAN connected to an external connection, such as the Internet, from external attacks while allowing authorized users to access the LAN from remote locations via the Internet or via dial-up access. With a typical firewall, the authorized user must go through an authentication process, such as entering a username and password, after which they have access to the internal network according to their security level. There is an implicit assumption that the user is given some level of trust once they are authenticated by the firewall. Within the security perimeter of the local area network, users may be able to communicate freely. However, all messages sent to or from users outside the local area network must pass through the firewall computer, which typically checks destinations and may label all information that passes into the LAN through the firewall so that internal applications know that the data packet originated outside the LAN. The firewall can be a conventional computer running specific firewall software, or a dedicated computer device specifically constructed or configured as a firewall. The firewall can be dedicated solely to performing the firewall functions, or it can also perform additional functions such as packet routing, or the like, in addition to its firewall functions.

Numerous known firewalls have been proposed, for example Cisco's White Paper, Cisco's PIX (Private Internet Exchange) Firewall and Stateful Firewall Security which describe a firewall that uses dynamic address allocation for connections initiated either inside or outside the network. In order to track each Transmission Control Protocol (TCP) connection established through the PIX Firewall associated with a particular host, state information is retained.

Shipley, in U.S. Pat. No. 6,304,975 teaches an intelligent network security device residing within a computer local area network. The device examines information being communicated within the network. In an Ethernet system, for example, the device examines data packets to recognize suspicious patterns of behavior. The device is connected to control a firewall such that unauthorized or disruptive outside users can be blocked from accessing the network. Blocking occurs in several degrees, depending upon the assigned seriousness of a breach attempt, such that less serious perceived attempts are allowed to continue to communicate with the network at some level, or to resume communications after a period of time. While Shipley's proposed device may aid the firewall to detect undesirable activity by outside users, those same users have access to the full network until such activity is detected. Consequently, the ingenuity of those outside the network needs either to be anticipated or countered by the intelligence of the device monitoring traffic through the firewall. Also, the security device may cause an undesirable limitation in data rate through the firewall due to its scanning of every packet.

The industry standard OSI architecture defines 7 layers of services in a network hierarchy. Layer 2 and layer 3 methods such as virtual private networks (VPN) can be used to provide secure access to a LAN or wide area network (WAN). However, a VPN typically requires special client software to be installed on all devices desiring access to the LAN or WAN, in addition to user ID and password logon. And once accepted, the user has full access to the corporate network, typically without restriction. While it is possible to apply restrictions such as limiting access to specific network addresses, the type of access given is otherwise similar for all users.

### SUMMARY OF THE INVENTION

An object of the present invention is to provide an improved communications firewall.

Accordingly, the present invention uses diverse ports for different services and restricts services to specific ports, i.e. the invention maps ports to service. Consequently, full network services access is not provided; only access to a specific port for a specific service.

According to an aspect of the present invention there is provided a communications firewall comprising a plurality of ports, and a plurality of services associated with the plurality of ports, with access to a client via any given port limited to one of the plurality of predetermined services.

According to an aspect of the present invention there is provided a method of providing a communications firewall comprising steps of providing a plurality of ports, associating a plurality of services with the plurality of ports, a first service initiating communications with a client via a first port, and continuing communications with the client via a second port by another service.

An advantage of the present invention is limiting access to only those services as needed by a client thereby preventing unauthorized access to all network services.

### BRIEF DESCRIPTION OF THE DRAWINGS

The present invention will be further understood from the following detailed description with reference to the drawings in which:

FIG. 1 illustrates in a system block diagram, a service terminal and a terminal-compatible vehicle, wherein liquid and gaseous fuels, water, electricity and data are exchangeable between the terminal and the vehicle;

FIG. 2 illustrates in a perspective view, a wheel stop service port of a service terminal in FIG. 1;

FIG. 3 illustrates in a perspective view, a connectivity device mountable to a vehicle;

FIG. 4 illustrates in an energy exchange network including a coupling system;

FIG. 5 illustrates a block diagram of a known firewall;

FIG. 6 illustrates an access controller in accordance with an embodiment of the present invention.

### DETAILED DESCRIPTION OF THE PREFERRED EMBODIMENT

An energy exchange system as described includes a service terminal for coupling vehicles to exchange energy services, the terminal including vehicle coupling hardware and connection to energy service provider systems, and an energy exchange network governing the control and management of energy exchange between the connected systems.

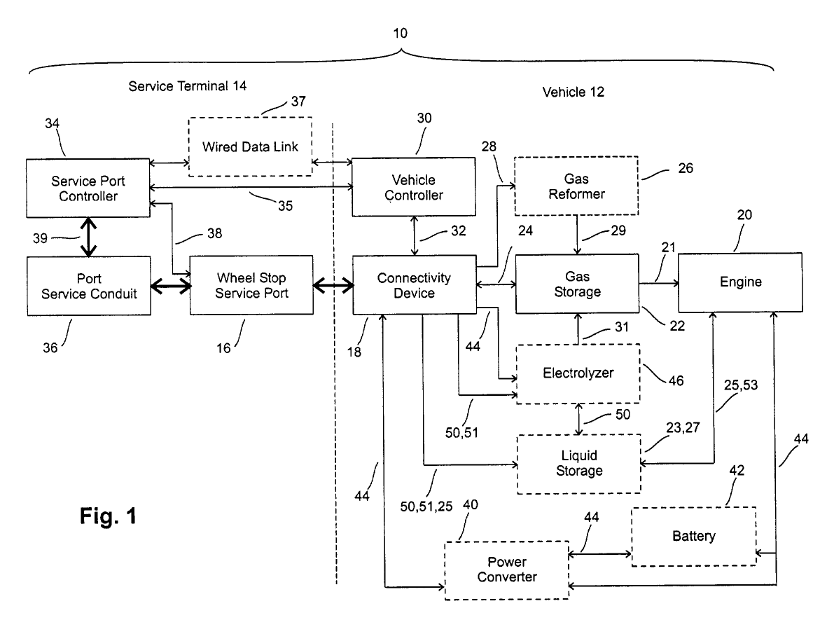

FIG. 1 illustrates an embodiment of a system 10 for transferring one or more of energy, material or data (collectivity referred to as “services”) between system-compatible vehicles 12 and a stationary service terminal 14. The service terminal 14 may be integrated into a building or pre-existing structure, or be part of a dedicated vehicle service terminal facility or be part of a mobile vehicle service port. In each embodiment, the service terminal 14 has a wheel stop service port 16 and the vehicle 12 has a connectivity device 18 that can couple to the wheel stop service port 16. Other major components of the service terminal 14 include a service port controller 34 for controlling the transfer of services by the wheel stop service port 16, and a port service conduit 36 for coupling the service terminal to one or more service destinations (not shown). The destination may be a service source when the service is to be transferred from the source to the vehicle 12; for example, the service source may be a fuel tank that supplies fuel to the vehicle when coupled to the service terminal 14. Or, the destination may be a service consumer when the service is to be transferred from the vehicle 12 to the consumer; for example, the service terminal 14 may be connected to a power grid, and the consumer may be an electricity user connected to the grid that receives electricity generated by a fuel cell onboard the vehicle and transferred to the grid when the vehicle is connected to the service terminal.

The system 10 is particularly suitable for providing services to fuel cell and regenerative fuel cell vehicles, but can also serve vehicles powered by other means, such as natural gas, liquid fuels, electricity, etc. The vehicle 12 has a number of components that make it compatible with the service terminal 14; the type of components depend on what services are being transferred.

FIG. 1 illustrates an embodiment of a system 10 that is capable of transferring one or more of gaseous and liquid fuel, water, electrical energy and data between a service terminal 14 and a vehicle 12. The vehicle 12 may include some or all of the components as described in the systems illustrated in FIG. 1. The connectivity device 18 may include one or a combination of the service connections as described below. The wheel stop service port 16 has interfaces for at least gaseous fuel, liquid, electricity and data. The wheel stop service port 16 is suitable to work with the connectivity device 18 of any vehicle, regardless of the maximum number of service connections on the connectivity device 18. An additional function of the system 10 is that the type of connectivity device 18 and the type of service required is determined by communication between the vehicle controller 30 and the service port controller 34. The service port controller 34 provides control signals through the control signal wire 38 to the wheel stop service port 16 directly, or via control signal wire 39 and port service conduit 36 to control the transfer of only those services suitable for the identified connectivity device 18.

The connectivity device 18 is electrically communicative with a vehicle controller 30 via control signal wire 32, which controls operation of the connectivity device 18; for example, the vehicle controller 30 provides automatic connection and gas transfer control signals to control the transfer of gaseous fuel through the connectivity device 18. The vehicle controller 30 has a transceiver (not shown) to exchange data wirelessly with a transceiver (not shown) in a service port controller 34 of the service terminal 14 (wireless link shown as 35). The construction of the controllers 30, 34 are known in the art. Optionally, a wired data link 37 may be substituted for the transceivers; in such case, data line connection points (not shown) are provided on each of the wheel stop service port 16 and the connectivity device 18 that connect when the wheel stop service port 16 and the connectivity device 18 are coupled or alternatively data can be sent over the electrical power connections. The data communicated to and from the vehicle controller 30 relates to providing data-related services that include vehicle identification, and fueling processes.

The connectivity device 18 has a gas transfer port (not shown) that is sealably connectable to a gas transfer port (not shown) of the wheel stop service port 16 to enable the transfer of gas between the vehicle 12 and the service terminal 14. The connectivity device 18 is connected to a gas storage cylinder 22 by way of gas line 24. Gas line 24 is bi-directional to enable fuel to be transmitted from the service terminal 14 to the vehicle 12, or vice versa. The gas storage cylinder 22 is fluidly connected to the engine 20 by way of gas transfer line 21. In one embodiment, gaseous fuel is transferred and reformed so that constituents such as hydrogen gas can be stored on-board the vehicle. A gas reformer 26 is provided that is connected to the connectivity device 18 via gas line 28, and connected to the gas storage cylinder 22 via gas line 29, so that gaseous fuel transmitted from the wheel stop service port 16 can be first reformed before being stored in the gas storage cylinder 22 and used by the engine 20.

An embodiment of the service terminal 14 is to provide the function of electricity transfer to or from the vehicle, for the purposes of powering onboard electrolysis or storage charging, and for transferring generated electricity from the vehicle back through the service terminal. In this case, the connectivity device 18 is configured to transmit electric power between the service terminal 14 and the vehicle 12, and the vehicle controller 30 is configured to control the transmission of electrical energy by the connectivity device 18. Electrical cables 44 electrically couple the connectivity device 18, power converter 40, battery 42, and the engine 20. Similarly, the wheel stop service port 16 is configured to transmit electric power between the service terminal 14 and the vehicle 12, and the service port controller 34 is configured to control the transmission of energy by the wheel stop service port 16.

A potential use of the service terminal 14 is to transfer liquid fuel such as gasoline. The connectivity device 18 is configured to transfer liquid fuel between the service terminal 14 and the vehicle 12, and the vehicle controller 30 is configured to control the transmission of liquid by the connectivity device 18. Similarly, the wheel stop service port 16 is configured to transmit liquid fuel between the service terminal 14 and the vehicle 12, and the service port controller 34 is configured to control the transmission of liquid fuel by the wheel stop service port 16. A liquid fuel storage tank 23 and liquid fuel lines 25 are designed to store and transmit liquid fuel as known in the art.

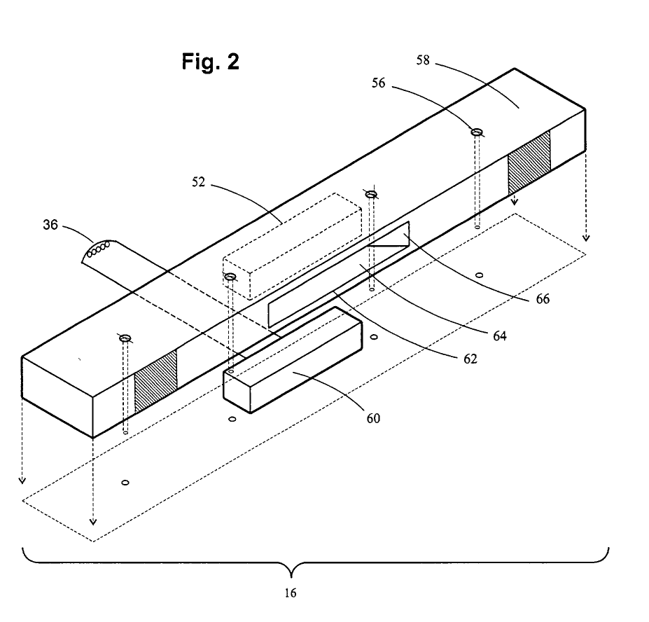

The service terminal 14, in one embodiment, may transfer water or other liquids to the vehicle for onboard electrolysis for hydrogen generation. A fluid storage tank 27 is provided to store water transferred from the service terminal 14, an electrolyzer 46 is provided to electrolyze the water to produce hydrogen gas, and a gas storage cylinder 22 is provided to store the hydrogen gas for use by the engine 20. Hydrogen fuel lines 21, 31 fluidly connect the gas storage cylinder 22 to the electrolyzer 46 and engine 20 respectively, and fluid supply and return lines 50, 51 fluidly connect the fluid storage tank 27 to the connectivity device 18 and the electrolyzer 46 respectively. Water is supplied to the vehicle 12 as hydrogen feedstock for the electrolyzer 46 via liquid supply line 50, and unused water from the electrolyzer 46 is returned through liquid return line 51. Water line 53 connects the fluid storage tank 27 to the engine 20 to return product water from the engine 20 and to supply water to humidify the gas stream. Both the connectivity device 18 and the wheel stop service port 16 are configured to transfer liquid and electricity between the service terminal 14 and the vehicle 12. Electrical cables 44 electrically connect the connectivity device 18 to the electrolyzer 46. The vehicle controller 30 is configured to control the operation of the connectivity device 18 to transfer water and electricity for the operation of the electrolyzer 46. The electrolyzer 46 is fluidly connected to the gas storage cylinder 22 through gas line 31. Referring to FIG. 2, the wheel stop service port 16 serves as a ground-mounted stationary docking location for vehicles 12 equipped with compatible connectivity devices 18. Such vehicles 12 couple to the wheel stop service port 16 and bi-directionally transfer services between the service terminal 14 and the vehicle 12. As mentioned, these services include electrical power, gaseous or liquid fuels, water or data. The wheel stop service port 16 is also designed to prevent the wheels of the vehicle 12 from traveling beyond a specific point in a parking stall and to locate the vehicle 12 in a position that places the vehicle's connectivity device 18 in a position for coupling to the service port 16. Other forms of service ports 16 may be used in the overall energy exchange network, including manual connections from service ports.

The wheel stop service port 16 has a generally elongate rectangular wheel stop housing 58 with fastening holes 56. The fastening holes receive a fastener (not shown) for fastening the service port 16 to a parking surface. Near the center of the front surface of the housing 58 is a recess opening 62 that opens into a receptacle recess 52. A connection bay 64 and a receptacle 60 are mounted inside the receptacle recess 52. The connection bay 64 has a front opening in the shape of a rectangular slot, and has tapered walls 66 that taper inwards both vertically and horizontally into the receptacle 60. The front opening of the connection bay 64 is flush with the recess opening 62. The receptacle 60 is mounted inside the receptacle recess 52 behind the connection bay 64 and also has tapered walls (not shown) that taper into the back wall of the receptacle. As discussed in detail below, the tapered walls 66 serve to guide a service plug 70 from the vehicle's connectivity device 18 into a coupling position inside the receptacle 60, i.e., into a position where the plug contacts the back wall of the receptacle.

In this description, the receptacle 60 and plug 70 are collectively referred to as a “service coupling”. Furthermore, the connection bay 64 and receptacle 60 are collectively referred to as the “connection bay assembly”.

The tapered walls 66 act to guide, or “self-locate” the plug 70 into a coupling position, thereby removing the need to provide costly electronic coupling guidance systems. It is understood that other self-locating designs such as a funnel may be substituted for the tapered walls 66 as will occur to one skilled in the art.

The service port 16 is externally controlled by the service port controller 34 via a signal conduit housed inside the service conduit 36. An externally controlled receptacle 60 allows system intelligence such as the service port controller 34 to be located elsewhere, enabling the service port 16 to be economically and easily replaced. Optionally, the service port 16 also has a port status indicator (not shown) located on the top surface of the housing 58.

The recess opening 62 is located on the front wall of the service port 16 but it may be located anywhere on the wheel stop housing 58. For example, the recess opening 62 may open from the top surface of the housing 58 such that the receptacle 60 and connection bay 64 receive a vertically deployed connectivity device 18.

The receptacle 60 is provided with service exchange interfaces that mate with corresponding service exchange interfaces on the plug 70 to effect a transfer of services therebetween. The service conduit 36 is coupled to the receptacle 60 at the back of the service port 16 and to service sources and/or destinations, thereby enabling the services to be transferred to and from the service port 14 and the service source/destination.

In an alternative embodiment, the service terminal 14 does not include the wheel stop service port 16 and in such case, a service port comprising the connection bay 64 and receptacle 60 are located elsewhere on the service terminal, and the corresponding location of the connectivity device 18 on the vehicle 12 of the alternative embodiment is at a position for coupling to the service port 16.

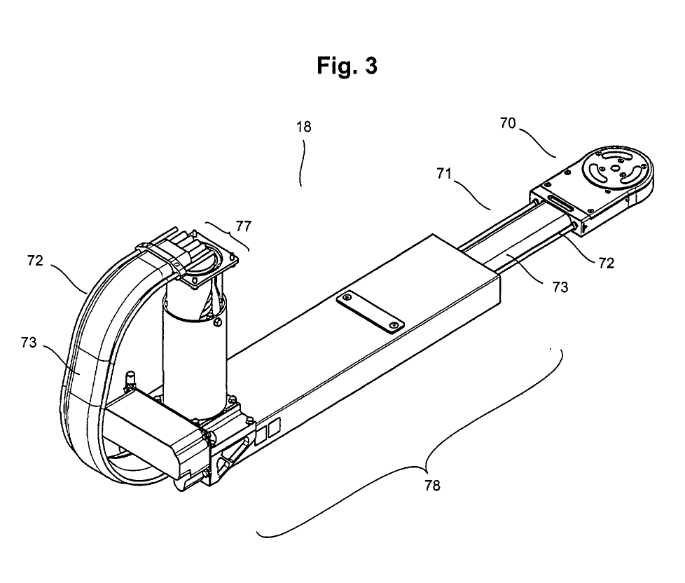

Referring to FIG. 3, the connectivity device 18 is for connecting the vehicle 12 to the service terminal 14 such that services can be exchanged therebetween. In this first embodiment, the connectivity device 18 is mountable to the front underside of the vehicle 12, has means to deploy the connectivity device from the vehicle, and has plug structures to couple to the receptacle 60 on the wheel stop service port 16 when the vehicle is in close proximity to the wheel stop service port. However, it is within the scope of the invention to mount the connectivity device 18 to a different part of the vehicle 12, or to mount the receptacle 60 to a different part of the service terminal 14. It is also within the scope of the invention to locate the connectivity device 18 on the wheel stop service port 16, and locate the receptacle 60 on the vehicle 12; in such case, the connectivity device extends from the wheel stop service port to couple to the vehicle when the vehicle is in close proximity to the wheel stop service port.

The major components of the connectivity device 18 are a plug 70 for coupling to the receptacle 60 of the service terminal 14, a compliant member 71 attached at one end to the plug, a deployment apparatus 78 attached to the compliant member for deploying the plug from a stored position into a deployed position and retracting same back into the stored position, and a vehicle mounting assembly 77 attached to the deployment apparatus 78 and mountable to the underside of the vehicle 12.

The compliant member 71 comprises a pair of flexible water lines 72 and flexible electrical cables 73 having a plurality of flexible electrical power conductors (not shown) housed within a protective jacket. The water lines 72 and the power conductors are coupled to components of the vehicle 12 that use or supply water and/or electricity. For example, the water lines 72 and electrical cables 73 may be connected to the on-board electrolyzer 46 to supply feedstock water and power the electrolyzer 46, respectively. Another option is that a hydrogen supply line is provided (not shown) for the purpose of direct fueling of the vehicle from a stored source of hydrogen.

In operation, the service coupling is engaged whenever the vehicle parks at a service port 16. The vehicle is typically parked at a service port 16 for fueling although it may also be parked to enable the transfer of information from or to the service port controller 34 and network controller (not shown in the figures). The connectivity device 18 is inserted into the receptacle 60 and is physically clamped in place by the clamp actuator (not shown) in the wheel stop service port 16. Typically the wheel stop service port 16 is fixed to the ground or parking structure and receives power from a fixed line. Thus the wheel stop service port 16 is able to physically fix the vehicle 12 in place independent of the vehicle power supply or vehicle engine systems. The docking process allows only an authorized user to unlock the docking mechanism. User authorization may be determined using a variety of techniques, such as: user ID and password; card and personal identification number (PIN); or biometric scan.

In one form of the invention the wheel stop service port 16 is installed at the vehicle owner's residence such that the vehicle can be fueled overnight or can generate power while parked at a private residence.

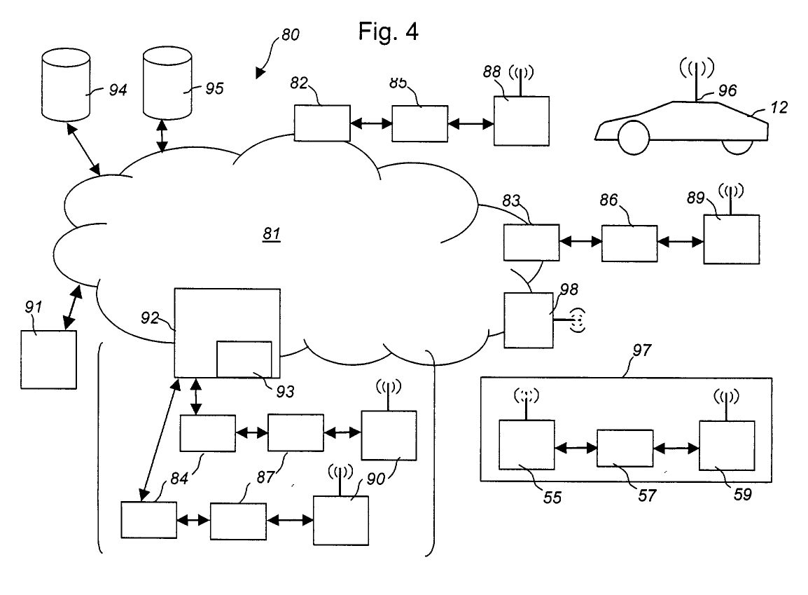

Referring to FIG. 4, there is illustrated an energy exchange network 80 including a coupling system in accordance with an embodiment of the present invention. The coupling systems are located at network nodes corresponding to service terminals 14 that include service port subsystems for communicating and coupling to vehicles 12 accessible to the network. An energy exchange station node controller 92 is located at energy exchange stations (not shown). An energy exchange station controls and manages multiple service ports 16 and coordinates network communications with individual service node controllers 82, 83, 84 at the service port. The station node controller 92 controls access to energy services and are connected to a plurality of service terminals 14 and enable management of local energy and services by the service terminals at that energy exchange station. An energy exchange network 80 includes a plurality of energy exchange network servers 91, a plurality of service node controllers 82, 83, 84, each coupled to an energy exchange network server via the wide area network 81. The wide area network 81 may include combinations of a private or public network, and technologies such as wireless, dialup, wired, satellite, broadband or internet systems. Service node controllers 82, 83 and 84 are coupled to access controllers 85, 86, 87, which in turn are coupled via node transceivers 88, 89, 90 to vehicles 12 provided with a corresponding communications transponder 96 or transponders 96. The access controllers 85, 86, 87 restrict services of their respective service node controllers 82, 83, 84 according to authorizations associated with potential users, such as a user corresponding to node transponder 96.

Each node transceiver 88, 89, 90 establishes a wireless local area network (LAN). Each node may be serviced by a single wireless LAN as illustrated in FIG. 4, or may have multiple wireless transceivers establishing multiple wireless LANs.

The energy exchange station node controller 92 is communicable with the service node controllers 84 associated with service terminals 14 located at the energy exchange station (not shown) and may control services provided through the associated service terminals, as well as local energy storage and distribution. In this example, the station node controller 92 communicates directly with the wide area network 81, and the service node controllers 82, 83, 84 communicate requests to the network through the station node controller. The station node controller 92 or individual service node controllers 82, 83, 84 may have a local cache 93 for storing authorization data and profiles, to enable services even when there is no connection to the network 81. The local cache 93 may include a database.

In either case, access to service node controllers 82, 83, 84 or via the wireless LAN is restricted by access controllers 85, 86, 87. Once the user corresponding to transponder 96 has docked the vehicle 12, a physical connection can optionally be established to support a data link between the access controller 85, 86, 87 and the transponder, consequently at least some of the ports can be accessed through a wired port in the vehicle coupling.

The energy exchange network server 91 provides energy services and management of distributed energy exchange transactions, manages transactions with energy service providers 94 and 95 (ESP) including buy and sell orders, and manages the energy exchange network 80 and service node controllers 82, 83, 84. Typically, a plurality of energy exchange network servers 91 is connected to the wide area network 81 to maintain a large scale of users and transactions. Data related to energy service providers 94 and 95 may be accessed via the energy exchange network 80 and the wide area network 81 and used to control buying and selling energy between the networked subsystems of the energy exchange network. An energy exchange network server 91 may include access to databases (not shown) for vehicle and user authentication and transaction data.

Users of the energy exchange network 80 may access the network through any of the energy exchange nodes or energy exchange network connections and may include ESP'S, service providers, owners of service ports, vehicle owners and network managers.

In another embodiment, a mobile service node controller 55, similar in function to the above described stationary energy exchange service nodes, may be located in a mobile service port 97 to provide networked energy services. The function of the mobile service port 97 is to provide energy exchange, roadside support, fleet fueling, defueling, and emergency services to vehicles or other devices that require such services distant from a stationary energy exchange service system. In this embodiment, the wide area network 81 includes a second wireless network for mobile communications 98, which communicates wirelessly with the mobile service port 97 by way of a wireless connection with a mobile service node controller 55. The wireless connection between the network for mobile communications 98 and the mobile service node controller 55 is effected by commonly available mobile communications including cellular or satellite networks. The mobile service node controller 55 is in turn coupled to a mobile access controller 57, which in turn is coupled via mobile node transceiver 59 to vehicles 12 provided with corresponding communications transponder 96 or transponders 96. The mobile service port 97 includes an automated service port 16 that is automated, and optionally a service port with manual connection.

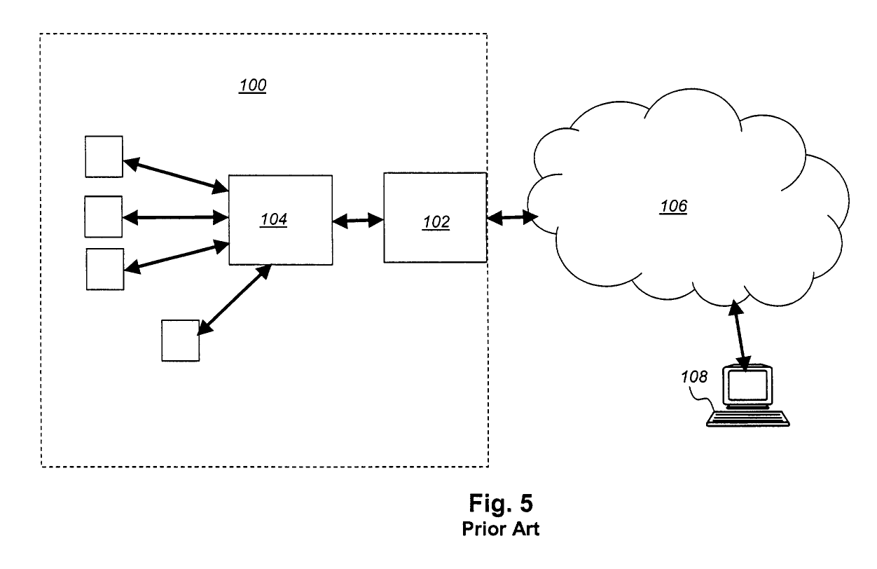

Referring to FIG. 5, there is illustrated in a block diagram a known firewall. A corporate LAN or WAN 100 includes the known firewall 102, which is typically positioned between a corporate server 104 and a public network 106, such as the Internet. The firewall 102 allows a user 108 to access the corporate server 104 via the public network 106, rather than via dial-up access. With the availability of high-speed Internet access, firewalls allow users to have high-speed access to the corporate LAN, WAN or intranet, such that the user enjoys a responsiveness similar to that provided through an onsite corporate network connection.

Such corporate networks 100 typically also use security methods such as virtual private networks (VPN) to provide an additional level of secure access to a LAN or WAN. However, a VPN typically requires special client software to be installed on all devices desiring access to the LAN or WAN, in addition to user identification and password log-on. For corporate users these can be easily downloaded while connected onsite, then used off-site in a portable device such as a laptop computer. Once accepted, the user has full access to the corporate network, typically without restriction. While it is possible to apply restrictions, such as limiting access to specific network addresses, the type of access given is otherwise similar for all users.

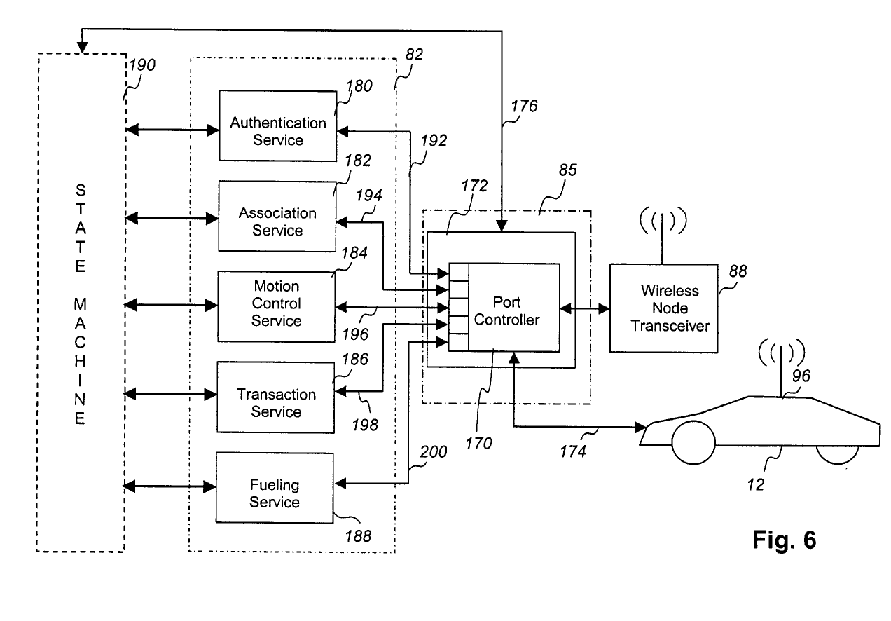

Referring to FIG. 6, there is illustrated the access controller 85 of FIG. 4 in further detail in accordance with an embodiment of the present invention. The site access controller 85 includes a port controller 170 and a firewall application 172. The service node controller 82 includes a plurality of services 180, 182, 184, 186 and 188. The port controller 170 is coupled to the wireless transceiver 88 for communications with a user vehicle 12. Following operation of the motion control service 184, the user vehicle 12 is physically docked and an optional wired communications path 174 becomes available for communicating with the firewall and services while the vehicle remains docked. The plurality of services include an authentication service 180, an association service 182, and a motion control service 184. Each of the services in the firewall interfaces with a corresponding portion of a state machine 190 (collectively represented by a block), running on the access controller 85. The state machine 190 running on the access controller 85 communicates with the firewall application 172 via a control path 176, to determine port status information such as port status, port open durations and transmission characteristics, and to transmit open or close instructions. The firewall application 172 and port control is therefore dynamically configured externally through this control path rather than having fixed settings. The state machine 190 can control and disable any port in the port controller 170 through the firewall application 172, based on service application logic. Further detail of the access controller 85 and associated software are not necessary for understanding the present embodiment; consequently are not provided herein.

FIG. 6 illustrates the energy exchange services available at an energy exchange node (not shown). Because the firewall is located within the vicinity of the user it is possible to make use of other interfaces within the authentication process. Vehicles adapted for the energy exchange network 80 are equipped with proximity detection devices (not shown). The proximity detection device is used to assist in coupling the user vehicle 12 to an energy exchange service terminal 14. The connectivity device 18 on the vehicle also provides an external indication of the presence of an authorized vehicle.

Because the energy exchange site may be used by the general public the idea of trusted users does not apply. Consequently, at no time should the firewall provide uncontrolled access to the services within the site network.

The purpose of the firewall is to allow access to the energy exchange network resources provided by the access controller 85. The services within the access controller 85 act as trusted applications that act as proxies for the user vehicles 12. It is the site services that are allowed access to the user, rather than the user that is allowed access to the site services.

In operation, the firewall tightly controls all access through the firewall allowing only the appropriate level of access to proceed uninhibited. At any given moment, only access to the services required to support a current state of the energy exchange transaction is allowed through the firewall.

The basic sequence in the energy exchange transactions is:

1. User authentication, managed by the authentication service 180;

2. Energy exchange service terminal association, managed by the association service 182;

3. Energy exchange connectivity device coupling, managed by the motion control service 184;

At each point in the sequence the user vehicle 12 is communicating with different services within the site. The firewall limits the communications to those services that are required at that point in time.

In Step 1, user authentication is controlled by the authentication service 180. For the purposes of authentication, the port controller 170 provides one open port, for external communication. When a user vehicle 12 approaches, the node transceiver 88 picks up the signal from a transceiver 96 in the user vehicle. The node transceiver 88 communicates with the authentication service 180 via a communications channel 192. The authentication service 180 then acts as an interface between the user vehicle 12, the authentication services provided by the access controller 85, and the service node controller 82, as represented by the state machine 190. Once satisfied with the authenticity of the user vehicle 12, the state machine 190 passes communications control from the authentication service 180 to the association service 182. The association service 182 associates a particular user vehicle 12 with an energy exchange service terminal 14 associated with individual node controllers, each of which have a unique identification. The association service 182 communicates with the user vehicle 12 via a newly established communication channel 194. Only the association service 182 has access to the user vehicle 12 at the time. The communications channel 194 may be used for providing vehicle docking instructions that may be visually displayed or provided as audio instructions, or both, in order to guide the user vehicle 12 to park near the appropriate energy exchange service terminal 14. Where control of parking is automatic, the communications channel 194 is by the association service to remotely controlled vehicle steering and throttle to effect parking.

Once the user vehicle 12 is parked, a connectivity device 18 as shown in FIG. 1 and FIG. 3 is deployed to effect physical connection between the user vehicle 12 and the energy exchange service terminal 14 associated therewith.

The deployment of the connectivity device 18 is controlled by the motion control service 184. The motion control service 184 communicates with the user vehicle 12 via a communications channel 196 to effect docking of the connectivity device that physically connects the vehicle to the associated energy exchange service terminal 14. The connectivity device 18 may be on the vehicle or the energy exchange service. The motion control service thus assumes control, via communication channel 196, of the connectivity device 18 to effect movement to engage the energy exchange service terminal 14.

Once the vehicle has been serviced, the firewall application 172 steps back through the services to decouple the connectivity device 18 through the motion control service 184; disassociate the energy exchange service terminal 14 through the association service 182; and finally un-authorize the user vehicle 12 through the authentication service 180. The state machine 190 can disable any port based on the control logic associated with each service.

The user vehicle 12 may be equipped with other communications devices that can be used in concert with the wireless communications at appropriate times during the process described with regard to FIG. 6. For example, the user vehicle may include a radio frequency identification device (not shown) that communicates via a separate radio frequency (RF) channel (not shown) from that used by the wireless LAN. The user vehicle 12 may also be equipped with a data communications device coupled to the connectivity device for exchanging data while physically coupled to the energy exchange service terminal 14.

The energy exchange service terminal 14 may include sensors (not shown) such as proximity devices (not shown) to sense the presence of a vehicle in a service stall or near the energy exchange service terminal.

These other communications devices and sensors can be used by the firewall at various stages to provide a further level of security. For a user vehicle 12 equipped with a separate RF identification (not shown), the identification provider (not shown) could be used by the authentication service 180 to provide an advanced level of access.

Initially, the user vehicle 12 is only able to communicate with the authentication service 180 to allow for user identification. Once a user vehicle 12 has been identified the authentication service 180 hands off to the association service 182 the newly authenticated user. The association service 182 requests access to that authenticated user through the firewall. Proximity detection on the energy exchange service terminal 14 verifies the presence of the user vehicle 12 for the association service 182. The association service 182 then signals the motion control service 184 that a user vehicle 12 is present in front of the associated energy exchange service terminal 14. The motion control service 184 then requests access to the authenticated user through the firewall. Once the connectivity device 18 has docked with the port, the motion control service 184 hands off to the transaction service 186. A data connection via the connectivity device 18 could be used at this stage to communicate with the vehicle docked at a service port. The services disconnect from the user vehicle 12 when they are no longer required.

What is claimed is:

1. A communications firewall comprising:
a first port for establishing a first communications link for use by a first service; and
a second port for establishing a second communications link for use by a second service using information provided by the first interface.

2. A communications firewall comprising:
a plurality of ports; and
a plurality of services associated with the plurality of ports, operable to provide access to a client via a specific port allocated to a predetermined service, and to restrict access to non-allocated ports.

3. A communications firewall as claimed in claim 2 wherein a service includes an activity.

4. A communications firewall as claimed in claim 3 wherein a completion of an activity by one service effects a call to another service.

5. A communications firewall as claimed in claim 4 wherein a call to another service activates another port to access the client.

6. A method of providing a communications firewall comprising steps of:
providing a plurality of ports;
associating a plurality of services with the plurality of ports, each service restricted to a predetermined port;
initiating communication with a client via by a first restricted service via a first port; and
continuing communication with the client by a second restricted service via a second port.

7. A method of providing a communications firewall as claimed in claim 6 wherein the step of initiating communication by the first restricted service includes the step of completing an activity, and completion of the activity establishes communications with the client.

8. A method of providing a communications firewall as claimed in claim 7 wherein the step of completing the activity by the first service includes the step of calling another restricted service.

9. A method of providing a communications firewall as claimed in claim 8 wherein the step of calling another restricted service leads to the step of continuing communication with the client via the second port to access the client.

10. A method of providing a communications firewall as claimed in claim 9 further comprising the step of continuing communication with the client via a third port by a further restricted service.
